(19) United States
(12) Patent Application Publication
(10) Pub. No.: US 2017/0118507 A1
(43) Pub. Date: Apr. 27, 2017

(54) SYSTEM AND A METHOD FOR PROCESSING VIDEO TUTORIALS

(71) Applicant: MIMESIS TECHNOLOGY SP. Z O.O., Krakow (PL)

(72) Inventors: Michal LATACZ, Krakow (PL); Wiktor WILK, Wieliczka (PL)

(21) Appl. No.: 15/317,128

(22) PCT Filed: Jun. 8, 2015
(86) PCT No.: PCT/EP2015/062703

§ 371 Date: Dec. 8, 2016

(30) Foreign Application Priority Data
Jun. 9, 2014 (PL) P.408468

(51) Int. Cl. H04N 21/44; G11B 27/02; H04N 21/431; H04N 21/414; H04N 21/845; H04N 21/422

(52) U.S. Cl. CPC H04N 21/44; H04N 21/8456; H04N 21/42203; H04N 21/4312; H04N 21/414; G11B 27/02

(57) ABSTRACT

A system for processing video tutorials (201) comprising a plurality of sections (202), the system comprising: a display interface (405) for outputting a video signal corresponding to the video tutorial (201); a controller (406) for providing video data to the display interface (405), the controller being configured to: receive (301) a descriptor of the video tutorial (201) specifying its sections (202); receive (302) the video data corresponding to the sections (202) according to the sequence defined by the descriptor; process (304) the video data of the section (202) depending on the type of the section (202) or a section fragment (204), and output the processed video data to the display interface (405); wherein the type of a section (202) or a section fragment (204) defines at least one of: once-type section or fragment to be processed by playing the contents of the section (202) or the fragment (204) once; loop-type section or fragment to be processed by playing the contents of the section (202) or the fragment (204) in a loop until receiving from a user interface (402, 403, 409, 411) a command to move to the next section (202) or fragment (204).

### TECHNICAL HELD

The present invention relates to a system and a method for processing video tutorials, such as cooking tutorials. It relates to the technical areas of video data processing, video data presentation and user interfaces of video players.

### BACKGROUND

The increasing amount of tutorial content in form of videos, generated both by professional and amateur content providers, calls for improvements in the way the content is presented, in order to make it more attractive for the user.

Video tutorials are provided for a great variety of topics: cooking, dancing, language learning, make-up, etc.

In case the tutorial relates to an advanced topic, or the user is inexperienced, the user may find it difficult to learn the topic from the tutorial in case it is played too quickly.

There are known various systems for processing and presenting video tutorials, related in particular to cooking tutorials.

For example, a US patent application US2002/0171674 discloses a system and method for providing food-related information, including recipes, methods, hints and cooking instructions to a user via an interactive computer at a food-related location, such as a kitchen. The interactive computer includes a graphic-user interface (GUI) and one or more speakers, and the GUI is preferably a touch-screen capable of displaying interactive multimedia applications to the user, such as video cooking-step illustrations. The interactive computer alternately further includes a secondary storage device that provides food-related information to the user from a secondary storage media such as a CD-ROM or floppy disk.

A U.S. Pat. No. 8,335,796 discloses a recipe providing system and a recipe providing method for presenting a suitable recipe that matches to a user request on specific foodstuff basis and/or specific cooking process basis. A recipe element storing unit stores a recipe element data related to recipes. The recipe elements are hierarchized according to cooking process of one recipe and each of the recipe element has link information to a finished-dish for which the recipe element is used. A recipe generating means retrieves/extracts recipe element data from the recipe element storing unit in accordance with users recipe request, and generates a recipe. A recipe sending means sends the recipe generated by the recipe generating means to users.

It is therefore the aim of the system and method presented herein to improve the known methods of processing video tutorials, in order to make them more user-friendly and allow the tutorial content to be easily watched, especially by an inexperienced user.

### SUMMARY

There is presented herein a system for processing video tutorials comprising a plurality of sections. The system may comprise:
a display interface for outputting a video signal corresponding to the video tutorial;
a controller for providing video data to the display interface, the controller being configured to:
   receive a descriptor of the video tutorial specifying its sections;
   receive the video data corresponding to the sections according to the sequence defined by the descriptor,
   process the video data of the section depending on the type of the section or a section fragment, and output the processed video data to the display interface;
   wherein the type of a section or a section fragment defines at least one of:
      once-type section or fragment to be processed by playing the contents of the section or the fragment once;
      loop-type section or fragment to be processed by playing the contents of the section or the fragment in a loop until receiving from a user interface a command to move to the next section or fragment.

There is also presented a computer-implemented method for processing video tutorials comprising a plurality of sections. The method may comprise the steps of:
receiving a descriptor of the video tutorial specifying its sections;
receiving the video data corresponding to the sections according to the sequence defined by the descriptor,
processing the video data of the section depending on the type of the section or a section fragment, and outputting the processed video data;
wherein the type of a section or a section fragment defines at least one of:
   once-type section or fragment to be processed by playing the contents of the section or the fragment once;
   loop-type section or fragment to be processed by playing the contents of the section or the fragment in a loop until receiving from a user interface a command to move to the next section or fragment.

The loop-type fragment of at least one section can be located at the beginning of the section.

The loop-type fragment of at least one section can be located at the middle of the section. The loop-type fragment of at least one section can be located at the end of the section.

At least one section or fragment may have an ending sequence of video frames which is a reverse of a beginning sequence of video frames of that section or fragment.

At least one section or fragment may have an ending sequence of video frames which is a reverse of a beginning sequence of video frames of a beginning sequence of a following section or fragment.

The controller can be configured to process the loop-type sections or fragments by generating an extended continuous loop by adding to the basic video data a copy of its frames in a reverse order and outputting the extended continuous loop in a loop.

The descriptor of the video tutorial may specify at least two sections to be displayed simultaneously.

The at least two sections to be displayed simultaneously may have a display type defined, being one of:

a picture-in-picture window or main window type;

a left-portion or right-portion type;

a top-portion or bottom-portion type.

The at least two sections to be displayed simultaneously may have a different length.

The at least two sections to be displayed simultaneously may have fragments of a different length.

The descriptor of the video tutorial may specify at least two fragments of one section or different sections to be displayed simultaneously.

The at least two fragments to be displayed simultaneously may have a display type defined, being one of:

a picture-in-picture window or main window type;

a left-portion or right-portion type;

a top-portion or bottom-portion type.

The controller can be configured to receive from the user interface a command to change the configuration of display of sections or fragments displayed simultaneously.

The controller can be configured to receive from the video tutorial descriptor a command to change the configuration of display of sections or fragments displayed simultaneously.

The controller can be configured, after receiving a command to move to the next section or fragment, to check, the amount of content of the currently played section or fragment and if it is shorter than a predefined threshold, to continue playing of that section or fragment until its end.

The controller can be configured, after receiving a command to move to the next section or fragment, to check, the amount of content of the currently played section or fragment and if it is longer than a predefined threshold, to increase the playback speed of that section or fragment until its end.

The sections may have a form of individual video files defined by locators specifying the location of the video files in a video sections database accessible to the controller.

The video sections database can be stored in a local memory of the system.

The video sections database can be remote to the system.

A section may form a part of at least two different video tutorials.

The video data of a section can be a video shot from a first person perspective.

The user interface can be one of a touch interface, a proximity sensor, a microphone or a gesture detector.

The display interface can be coupled to a display screen which is embedded in a kitchen appliance.

The display screen can be embedded in a kitchen table counter top.

The display screen can be integrated with a weighing device.

The display screen can be tiltable.

In particular embodiment, there is presented a system for presenting cooking tutorials in form of video sequences, the system comprising a data bus configured to communicatively couple system components, a display interface for presenting the cooking tutorials, a memory and a system controller. The system may have the controller being configured to:
receive a cooking tutorial descriptor specifying sections of the cooking tutorial;
receive sections according to the sequence defined by the descriptor of the cooking tutorial;
play the cooking tutorial starting from the first section;
wherein the playback of at least some of the sections is performed such that the section is played in a loop until receiving from the user a command to move to the next section;
playing a next section.

In another particular embodiment, there is presented a method for presenting cooking tutorials in form of video sequences. The method may comprise the steps of:
receiving a cooking tutorial descriptor specifying sections of the cooking tutorial;
receiving sections according to the sequence defined by the descriptor of the cooking tutorial;
playing the cooking tutorial starting from the first section;
wherein the playback of at least some of the sections is performed such that the section is played in a loop until receiving from the user a command to move to the next section;
playing a next section.

### BRIEF DESCRIPTION OF DRAWINGS

The method and system are presented by means of example embodiments on a drawing, in which:

FIG. 1 illustrates a kitchen environment, wherein the system for processing video tutorials can be applied;

FIG. 2A illustrates an example of a video sequence;

FIG. 2B illustrates a continuous loop;

FIG. 2C illustrates another example of a video sequence;

FIG. 3 shows a method for processing video tutorials;

FIG. 4 shows a system for processing video tutorials;

FIGS. 5A-5C shows examples of user interface screens;

### NOTATION AND NOMENCLATURE

Some portions of the detailed description which follows are presented in terms of data processing procedures, steps or other symbolic representations of operations on data bits that can be performed on computer memory. Therefore, a computer executes such logical steps thus requiring physical manipulations of physical quantities.

Usually these quantities take the form of electrical or magnetic signals capable of being stored, transferred, combined, compared, and otherwise manipulated in a computer system. For reasons of common usage, these signals are referred to as bits, packets, messages, values, elements, symbols, characters, terms, numbers, or the like.

Additionally, ail of these and similar terms are to be associated with the appropriate physical quantities and are merely convenient labels applied to these quantities. Terms such as “processing” or “creating” or “transferring” or “executing” or “determining” or “detecting” or “obtaining” or “selecting” or “calculating” or “generating” or the like, refer to the action and processes of a computer system that manipulates and transforms data represented as physical (electronic) quantities within the computer's registers and memories into other data similarly represented as physical quantities within the memories or registers or other such information storage.

With the arrival of new technologies and broadband Internet access, people tend to exchange traditional recipes books with tablets and laptops that are brought into kitchens in order to display recipes to cooks.

It would thus be advantageous to have recipes information displayed in a pleasant, comfortable way.

### DETAILED DESCRIPTION

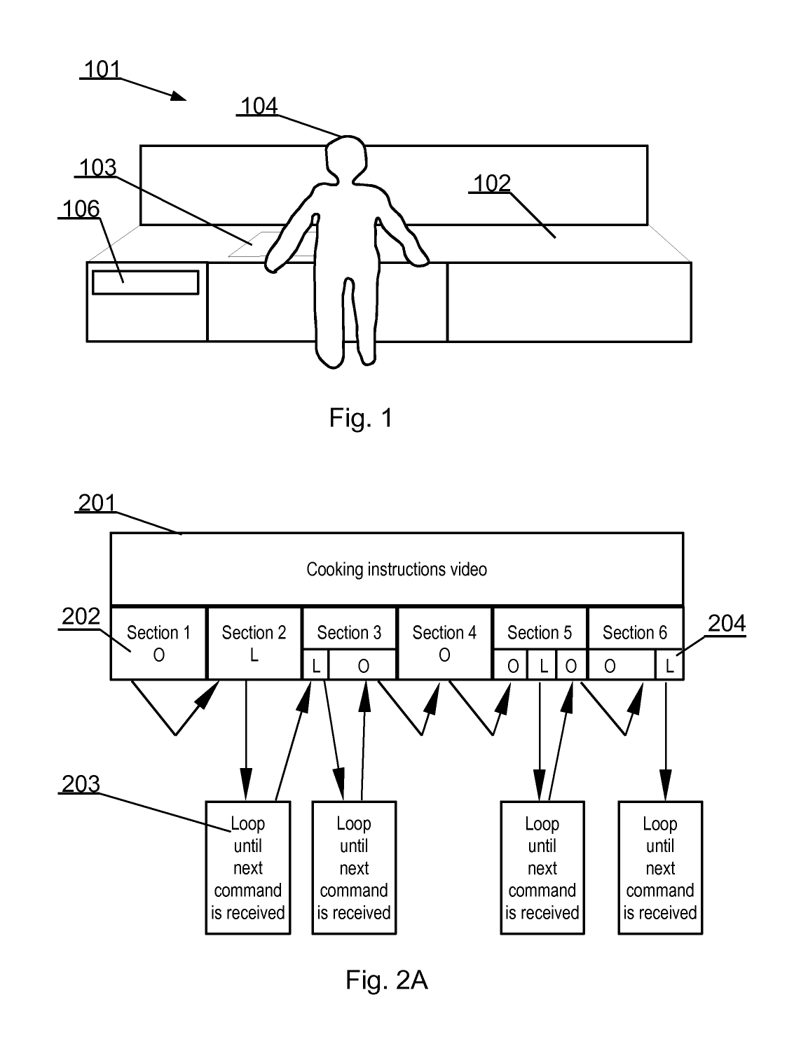

FIG. 1 illustrates, as an example, a kitchen environment wherein the system can be applied to process cooking tutorials.

In case of cooking tutorials, it is particularly important to minimize the distance of the person preparing the meal from the display screen, such as to present the recipe without having the user changing the location or gaze focus.

In the system presented herein, the cooking tutorials can be presented at any screen mounted at any place, for example at a self-standing display, at a display hang on a wall, a display mounted within a wall, a display mounted in a vertical wall of a kitchen furniture (such as a cabinet or a refrigerator door), etc. In a preferred embodiment, the videos are presented on a horizontal display which is built into the kitchen table counter, wherein food is prepared, therefore the distance between the screen and the user is minimized. When the display is covered by a durable glass, the user can even prepare meal directly on the display. Alternatively, the display can be positioned at some distance from the edge of the counter top and can be tilted, to avow most optimal viewing angle to the user.

The kitchen environment 101 presented in FIG. 1 comprises typical appliances and arrangements including a counter top 102. A display screen 103 is provided at the counter top so that a user 104 may prepare food while keeping his Is gaze down on the processed products, while at the same time looking at the recipe displayed on the screen 103, without the need to raise or turn around the head.

Preferably, the display 103 is protected with suitable seals and a curable transparent surface (such as hard glass comprising an anti scratch layer on top), such that the meal can be prepared directly on top the display 103. In case the display 103 is a touch screen and the user wishes to prepare products on top of the display, the touch responsive area may be limited to a small section of the display 103, such as to deactivate it at places where the user prepares the meal.

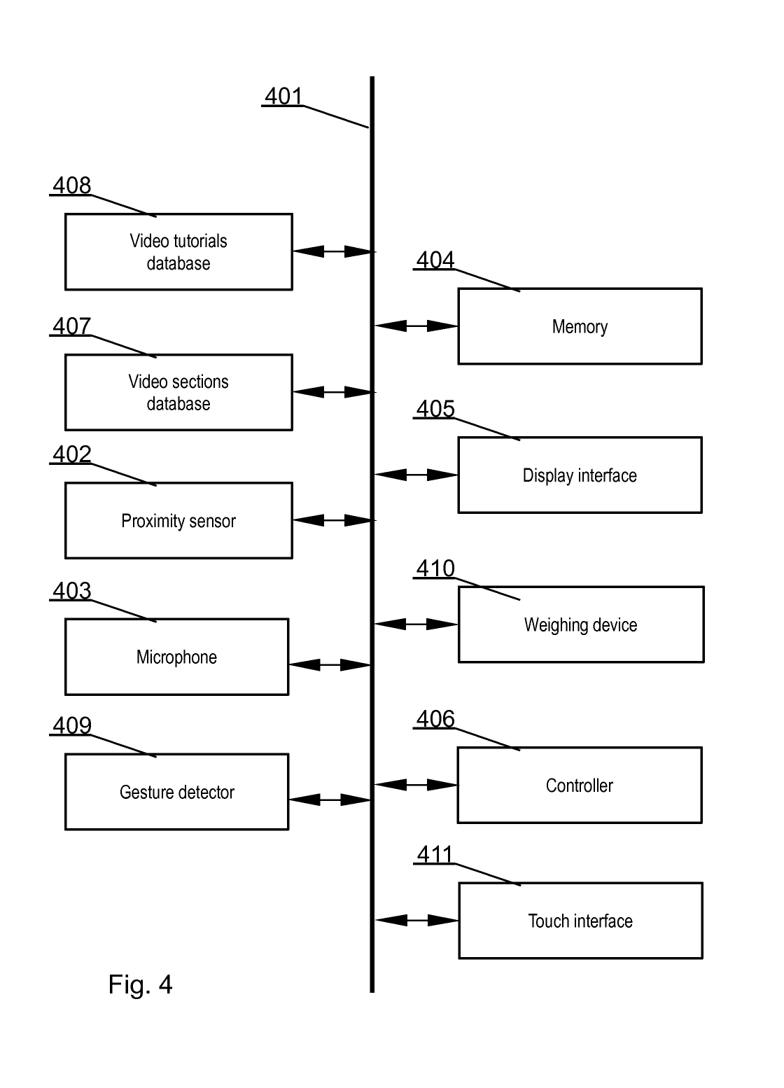

The display 103 may be integrated with or connected to a computer 106 providing video tutorial data. The computer 106 may be placed inside a kitchen cabinet and be invisible from the outside. Further details of the computer 106 will become apparent from FIG. 4 and its corresponding detailed description to follow.

The system and method presented herein are based on the ancient Greek concept of mimesis (imitation), meaning the copying of appearances of things. The system and method are designed so as to provide a convenient way to allow the user (the apprentice) to copy the actions presented by the video presenter (the master).

This is achieved by a combination of at least some of the following elements:
presenting the video tutorial at a minimum distance to the user;
filming the tutorial from a first person perspective;
dividing the video tutorial into sections;
for at least some of the sections, looping the whole section or the final phase to allow the user extended viewing time for the result;
moving to the next section after the user confirms having finished the previous section.

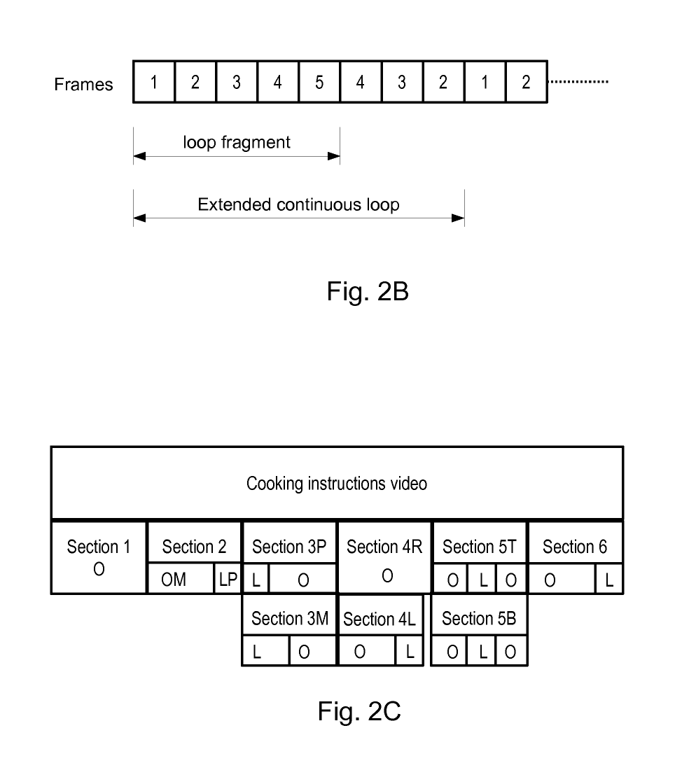

FIG. 2A illustrates an example of a video tutorial to be handled in the system.

The video tutorial 201 is divided into sections 202. Each section 202 may represent a single step of the whole activity covered by the tutorial, or a sequence of correlated steps.

For example, in case of a cooking tutorial, separate cooking actions such as cutting, whipping, boiling, seasoning, mixing ingredients can be covered by separate sections.

Preferably, the tutorial is filmed from a first person perspective, to show the actions done by the hands of the presented from the head viewpoint. Then, in case the user watches the tutorial on a display screen built into the kitchen counter top, the user can easily mimic the gestures of the presenter to copy the actions presented.

Each section 202 comprises a flag that determines whether this particular section shall be played in a loop (L) or played once (O). The flag can be set for the whole section (as for sections 1, 2, 4) or for a fragment 204 of the section (as for sections 3, 5, 6). The loop fragment can be at the beginning of the section (as for section 3), at the middle of the section (as for section 5), or at the end of the section (as for section 6).

The video content of the sections 202 or section fragments 204 indicated as loop-type is played in a loop as long as a user orders to move to the next section. This can be executed by the user by a voice command, such as by saying “done” or “next”. Alternatively, the user may tap the touch screen, make a touch gesture, press a button, or use a proximity sensor to switch between the sections back and forth.

Preferably, for at least some of the neighboring sections, the ending sequence of frames of a preceding section is identical to a starting sequence of frames of the following section. Such sequence can be from 2 to 100 frames long which represents typically up to four seconds of video content. This allows to hide the transitions between the sections from the user, so that the user perceives the tutorial as a continuous video.

The timing of transition to a following section can be dependent from the current position within the section played in a loop, if the currently played section is close to its ending, i.e. when the amount of content remaining to be played (measured e.g. as the number of frames or the length of the content to be played) is shorter than a predefined threshold, then it can be played until its end, i.e. all remaining video frames can be displayed and only after that the transition to the next section can be effected. In case when a significant portion of the section remains to be played, i.e. the amount of content is higher than the threshold, the playback speed of the remaining content can be increased until the end of the section or until a number of frames before the end of the section and only then the transition to the next section can occur.

Preferably, some frames in the video content can be identified as transparent (for example, having a transparency parameter or having its part filled with a uniform color, such as green or blue, similarly to “green box” or “blue box” techniques). This allows positioning therein other video content or a still picture. For example, the still picture can be adjusted to the color of the kitchen table top, wherein the user watches the recipe, such as to integrate the display of the recipe with the kitchen environment and concentrate user's attention on the presented activities of the recipe.

The objects present in video frames may be one of three categories: (a) static objects (e.g. cutting board), (b) moving objects (e.g. a knife) and (c) presenter's hands.

In order to facilitate making the final and beginning frames of neighboring sections identical, the moving objects and presenters hands should be introduced in to the shooting area from outside the frame and should leave the shooting area before the given video section ends.

Such video step-by-step navigation within a cooking recipe will help users to fully understand each section of the cooking process. When the recipe is presented from the first person's perspective view, it facilitates users to observe it closely and recreate the same actions in reality.

The individual sections 202 can be stored locally as individual files in the memory 106, and therefore can be used in different cooking videos 201. Therefore, a video recipe may comprise a descriptor file listing all related sections and their sequence. For, example recipe A may comprise sections 1 and 3 while recipe B may comprise sections 2, 3 and 5. Moreover, some sections can be stored in the local memory 106, and other sections may be accessed from a remote (network) location.

Preferably, the loop sections or fragments are configured such that the user perceives them as a continuous video, without recognizing the beginning and end of the loop. This is particularly useful when presenting to the user a desired effect of the activity presented in that section. The loops can be from 2 to 100 or even more frames long which represents typically up to four or more seconds of video material.

One way to achieve this is shown in FIG. 2B. A 5-frame loop fragment comprising frames no. 1, 2, 3, 4, 5 can be extended to a continuous loop by supplementing it with its own frames in a reverse order, starting from the pre-last frame (no. 4) and ending with the second frame (no. 2). The extended continuous loop fragment can be played in a loop (starting from its beginning until its end and again). The extended loop can be prepared within the video file at a post-processing stage. Alternatively, the extended loop can be prepared at the video player while the video tutorial is played. Alternatively, the loop type flag (L) can have two sub-types, e.g. a standard loop (SL) indicating that the loop is to be played from its beginning to its end and again, or an extended loop (EL) indicating that the loop is to be extended, i.e. played from its beginning to its end and reverse to its beginning and again.

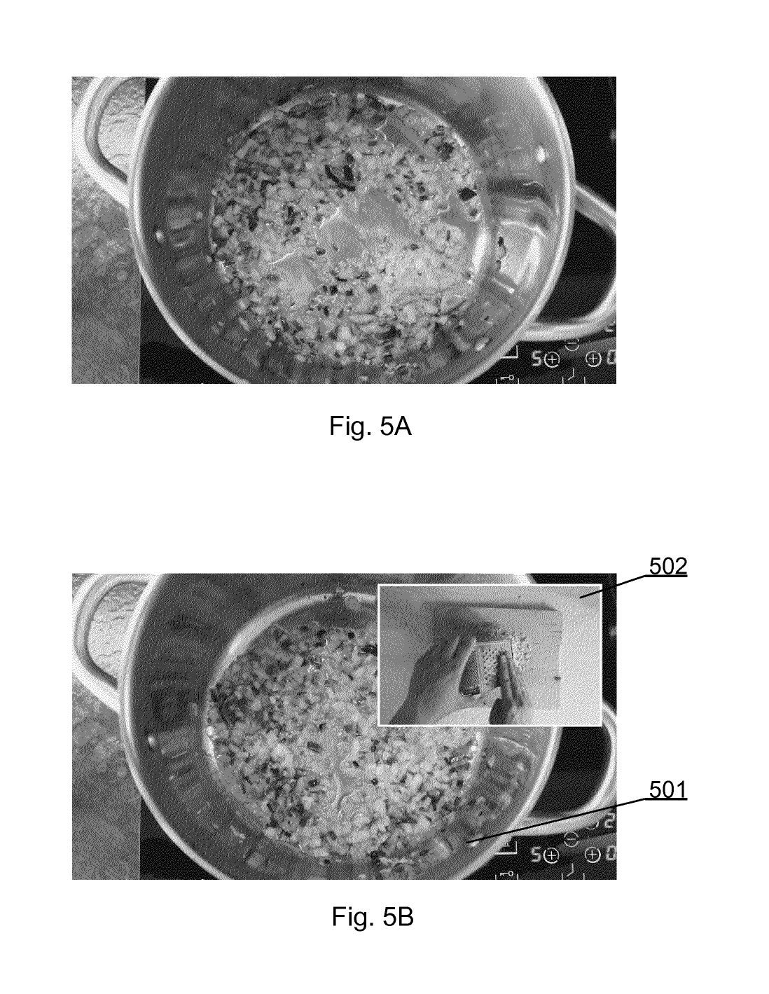

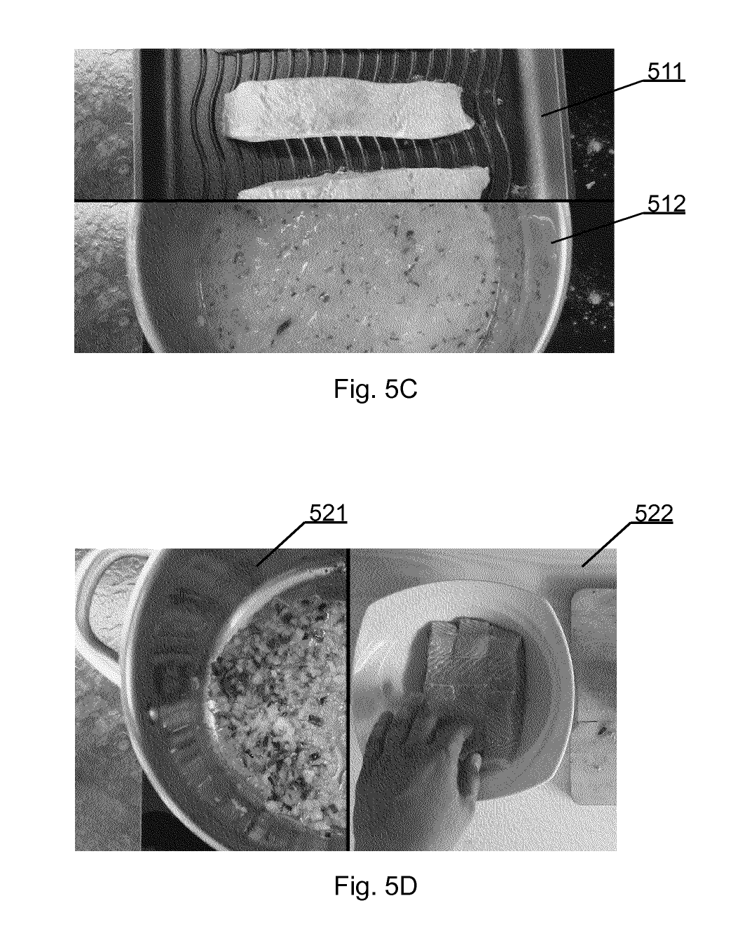

In that manner, the start and end of the loop are unrecognizable. This is particularly useful when presenting the user with an end of an activity. For example, when the activity is related to frying onion, it is particularly useful to indicate to the user the desired color and state of the fried onion while it fries. In that case, the tutorial video producer only has to film the whole activity as a section until the desired end moment. Preferably, the content of the end fragment comprises the view of the frying pan with the fried onion inside, as shown in FIG. 5. The end fragment (such as 25 frames or 1 second) of that section can be then indicated as a loop fragment. This fragment is then played in a loop to the user during presentation of the tutorial section, so that the user can continue cooking the onion until it achieves the same color and state as the one on the video, such as shown in FIG. 5A. Since the end section is played as a video, it is much more informative to the user than showing a still picture with the last frame of the video (the user can see not only the appearance of the result of the current section, but also how it behaves), Moreover, the user experience is not disrupted, as the user perceives the video tutorial as a continuous, interactive video, rather than individual sections.

A plurality of sections can be played on screen simultaneously. For example, as shown in FIG. 5B, the beginning fragment of first section can be played on the main section 501 of the screen, and the final fragment (e.g. the final loop fragment) can be played in a picture-in-picture section 502 of the screen, so that the user can simultaneously watch the current actions to be performed 501 and the desired effect 502. The picture-in-picture window can be displayed in a predefined position (defined in the configuration of the video tutorial or as predefined for the system in general), but that position can be changed by the user (for example, if the display is a touch screen, the window can be dragged to a different position, it can be also enlarged or decreased using the known touch gestures or other type of input). The position and/or size of the picture-in-picture window can be also defined in the video tutorial to be changed while the video is played, for example it can be defined to enlarge when particularly important action is performed.

Alternatively, two different sections can be played in a split-screen configuration, as shown in Fig. SC (top-bottom configuration) or FIG. 5D (left-right configuration). For example, one section can be played in a top portion 511 or left portion 521 of the screen, and another section can be played in a bottom portion 512 or right portion 522 of the screen. This is particularly useful when presenting activities that have to be performed simultaneously. The sizes of the individual windows can be predefined (defined in the configuration of the video tutorial or as predefined for the system in general), but that sizes can be changed by the user (for example, if the display is a touch screen, the split line can be dragged to a different position using the known touch gestures or other type of input). The size of the split windows can be also defined in the video tutorial to be changed while the video is played, for example it can be defined to have the more important actions displayed in a window of a larger size.

FIG. 2C illustrates another example of a video sequence, used to implement the functionality shown in FIGS. 5B-5D.

The video tutorial is divided into sections in a way similar as shown in FIG. 2A, with the following differences,

A plurality of video sections can have the same start timing in the tutorial. In that case, the sections may have assigned types specifying, how to display the particular section, such as:
a picture-in-picture window (section 3P) or main window (section 3M) display;
a right window (section 4R) or a left window (section 4L) display;
a top window (section 5T) or a bottom window (section 5B) display;
other types, such as left, right or middle display (for three sections to be played at a time), a top-left, top-right, bottom-left, bottom-right display (for four sections to be played at a time).

The types can be also defined for section fragments—for example, section 2 has a once-type fragment that is to be played in a main window and a loop fragment that is to be played in a picture-in-picture window. In that case, the main window shows the actions to be done and the picture-in-picture window shows the expected result. After the once-type fragment is finished, the main window may continue showing the loop fragment (in that case the picture-in-picture window can be closed, as it shows the same section).

Each section of the multiple sections played at a time may have its defined loop or once-type fragments. The length of the loop or once-type fragments can be different for the sections starting at the same time.

Moreover, the length of the sections starting at the same time can be different. For example, section 4L will have its final loop fragment played in a loop until the once fragment of section 4R is finished. In that case, the system may be configured via its settings whether it should move to the next section (once-type priority) or stop playing section 4R and play section 4L until receiving next command (loop-type priority).

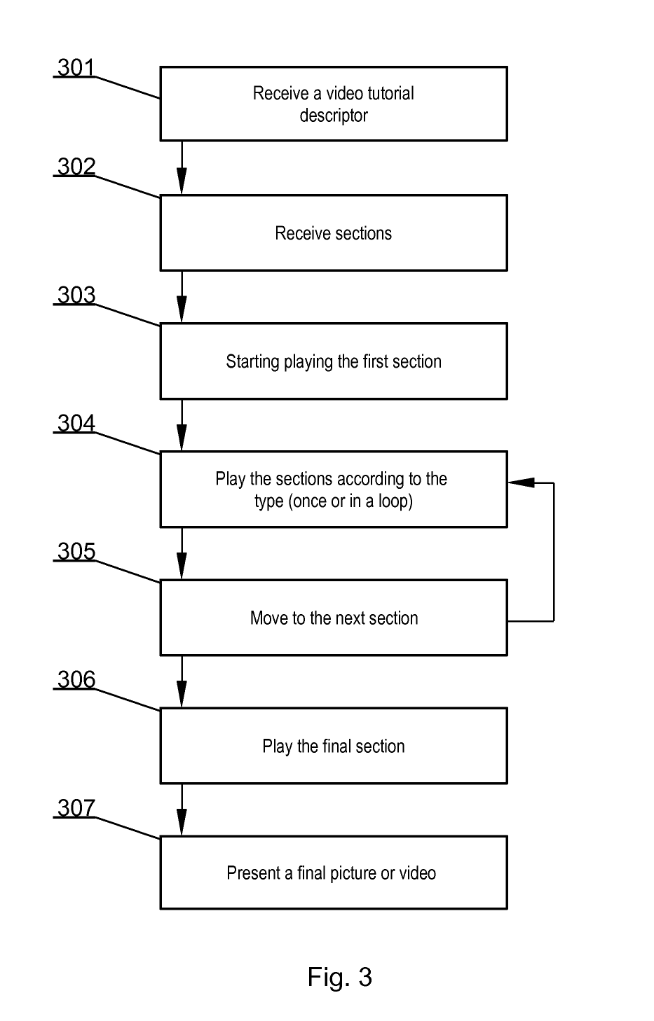

FIG. 3 shows a method for processing video tutorials. The method starts at step 301 from receiving a descriptor of a video tutorial. Such descriptor may comprise a name, description, a list of sections to be played in a sequence and additional data (such as a list of ingredients for a cooking tutorial). Each section may be described as a reference to video content, for example a reference to a video file stored at a local storage or a reference to a network location. In step 302 the sections are read to the memory.

The playback of the tutorial video is started from the first section 303. The sections are played in step 304 once or in a loop. The transition to the next section is effected in step 305 depending on the section type: for once-type sections it is effected after the playback of the current section is finished, and for loop-type sections it is effected after the user inputs a command to advance to the next section. All sections are played until the last section in step 306.

Some video tutorials may further comprise a final still picture or a final video section which is to be presented as the last one 307, For example, the final section of a cooking tutorial may show the ready-made meal. The user interface may comprise a special command to be activated by the user to move at any time to the last step 307. The final picture or video can be also used to present a summary of the video tutorial when a list of tutorials is presented to the user.

FIG. 4 shows the structure of the computer-implemented system for presenting video tutorials, comprising the display 103 and computer 106 of FIG. 1.

The system comprises a data bus 401 for enabling communication between the system elements. The system comprises a memory 404 for storing required software for the controller 406 and any temporary data needed for operation of the system, such as video and audio decoding buffers.

The controller 406 is configured to execute software that allows interaction with a user via a display screen 405, preferably a touch screen having embedded touch interface 411. Alternatively, the controller 406 may receive user input via other user interfaces such as a proximity sensor 402, a microphone 403 or a gesture detector 409.

In case the display screen is built in the kitchen counter top and the user can prepare the meal directly on the display screen, the display screen may be integrated with a weighing device 410 that measures the weight of the items placed on the screen (or on the protective glass which covers the display screen), so that the user can easily weigh e.g. the ingredients of the food to be prepared.

The controller 406 is configured to communicate with a video tutorials database 408 (such as a database of cooking recipes) which stores available tutorials. The tutorials comprise references to video sections which are stored in a video sections database 407. The controller 406 may download new tutorials from external sources via a suitable communication interface such as Wi-Fi or Ethernet port. A list of available recipes may be presented to a user on the screen via a display interface 405 which connects the computer 106 with the display 103.

It can be easily recognized, by one skilled in the art, that the aforementioned method for presenting video tutorials may be performed and/or controlled by one or more computer programs. Such computer programs are typically executed by utilizing the computing resources in a computing device such as personal computers, personal digital assistants, cellular telephones, receivers and decoders of digital television or the like. Applications are stored on a non-transitory medium. An example of a non-transitory medium is a non-volatile memory, for example a flash memory or volatile memory, for example RAM. The computer instructions executed by a processor. These memory media are exemplary recording media for storing computer programs comprising computer-executable instructions performing all the steps of the computer-implemented method according the technical concept presented herein.

While the invention presented herein has been depicted, described, and has been defined with reference to particular preferred embodiments, such references and examples of implementation in the foregoing specification do not imply any limitation on the invention. It will, however, be evident that various modifications and changes may be made thereto without departing from the broader scope of the technical concept. The presented preferred embodiments are exemplary only, and are not exhaustive of the scope of the technical concept presented herein.

Accordingly, the scope of protection is not limited to the preferred embodiments described in the specification, but is only limited by the claims that follow.

1. A system for processing video tutorials comprising a plurality of sections, the system comprising:
a display interface for outputting a video signal corresponding to the video tutorial;
a user interface for inputting commands to the system;
a controller for providing a video data to the display interface, the controller being configured to:
receive descriptor of the video tutorial specifying the sections;
receive the video data corresponding to the sections according to a sequence defined by the descriptor;
process the video data of the section depending on a type of the section or a fragment of the section, and output the processed video data to the display interface;
wherein the type of the section or the fragment defines at least one of:
a once-type section or a once-type fragment to be processed by playing contents of the once-type section or of the once-type fragment once;
a loop-type section or a loop-type fragment to be processed by playing contents of the loop-type section or of the loop-type fragment in a loop until receiving from the user interface a move command to move to a next section in the sequence or to a next fragment in the section.

2. The system according to claim 1, wherein the loop-type fragment of at least one section is located at a beginning of the section.

3. The system according to claim 1, wherein the loop-type fragment of at least one section is located at the middle of the section.

4. (canceled)

5. The system according to claim 1, wherein at least one section or fragment has an ending sequence of video frames which is a reverse of a beginning sequence of video in frames of that section or fragment.

6. The system according to claim 1, wherein at least one section or fragment has an ending sequence of video frames which is a reverse of a beginning sequence of video frames of a beginning sequence of a following section in the sequence or a following fragment in the section.

7. The system according to claim 1, wherein the controller is configured to process the loop-type sections or the loop-type fragments by generating an extended continuous loop by adding to the video data a copy of frames of the loop-type sections or the loop-type fragments in a reverse order and outputting the extended continuous loop in a loop.

8. The system according to claim 1, wherein the descriptor of the video tutorial specifies at least two sections to be displayed simultaneously.

9. The system according to claim 8, wherein the at least two sections to be displayed simultaneously have a display type defined, being one of:
a picture-in-picture window type or a main window type;
a left-portion type or a right-portion type;
a top-portion type or a bottom-portion type.

10. The system according to claim 8, wherein the at least two sections to be displayed simultaneously have a different length.

11. The system according to claim 8, wherein the at least two sections to be displayed simultaneously have fragments of a different length.

12. The system according to claim 1, wherein the descriptor of the video tutorial specifies at least two fragments of one section or different sections to be displayed simultaneously.

13. The system according to claim 12, wherein the at least two fragments to be displayed simultaneously have a display type defined, being one of:
a picture-in-picture window type or a main window type;
a left-portion type or a right-portion type;
a top-portion type or a bottom-portion type.

14-20. (canceled)

21. The system according to claim 1, wherein the sections have a form of individual video files defined by locators specifying the location of the video files in a video sections database accessible to the controller and at least one section forms a part of at least two different video tutorials.

22. The system according to claim 1, wherein the video data of at least one section is a video shot from a first person perspective.

23. (canceled)

24. The system according to claim 1, wherein the display interface is coupled to a display screen which is embedded in a kitchen appliance.

25. The system according to claim 1, wherein the display screen is embedded in a kitchen table counter top.

26. The system according to claim 1, wherein the display screen is integrated with a weighing device.

27. The system according to claim 24, wherein the display screen is tiltable.

28. A computer-implemented method for processing video tutorials comprising a plurality of sections, the method comprising the steps of:
receiving a descriptor of the video tutorial specifying the sections;
receiving a video data corresponding to the sections according to a sequence defined by the descriptor;
processing the video data of the section depending on a type of the section or a fragment of the section, and outputting the processed video data;
wherein the type of the section or the fragment defines at least one of:
a once-type section or a once-type fragment to be processed by playing contents of the once-type section or the once-type fragment once;
a loop-type section or a loop-type fragment to be processed by playing contents of the loop-type section or the loop-type fragment in a loop until receiving from a user interface a command to move to a next section in the sequence or to a fragment in the section.

29-50. (canceled)
